(19) United States
(12) Patent Application Publication
(10) Pub. No.: US 2003/0209481 A1
(43) Pub. Date: Nov. 13, 2003

(54) Tubular membrane module

(75) Inventor: Thomas Poschmann, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/428,666

(22) Filed: May 2, 2003

(30) Foreign Application Priority Data
May 8, 2002 (DE) 102 20 505.1

(51) Int. Cl. B01D 63/00

(52) U.S. Cl. 210/321.8; 210/321.89

(57) ABSTRACT

A tubular membrane module includes a a tubular jacket delimiting a flow path for a fluid containing a plurality of components, a plurality of tubular membrane bodies bundled together in a bundle and disposed in the tubular jacket, and at least one interspace element disposed between at least two adjacent membrane bodies of the plurality of membrane bodies. Each of the tubular membrane bodies has a surface and is permeable for a first component of the plurality of components. The interspace elements reduces a diffusion path of the first component to the surface of the membrane bodies.

Priority is claimed to German Patent Application No. DE 102 20 505.1, filed May 8, 2002, which is incorporated by reference herein.

### BACKGROUND

The present invention relates to a tubular membrane module having a plurality of tubular membrane bodies bundled together in a common tubular jacket. The tubular jacket delimits a flow path for a fluid containing multiple components. The membrane bodies are permeable for at least one component of this fluid to be separated.

Such tubular membrane modules are used, for example, in conjunction with gas generating systems in which hydrocarbons are reformed to produce a gas containing hydrogen. In this application, the tubular membrane modules are equipped with highly permeable membrane bodies and are used to separate hydrogen from the reformate gases.

When using tubular membrane modules, module effects may occur, having an overall negative effect on the permeation efficiency of the module. The effect of concentration polarization in particular prevents the maximum achievable theoretical permeation rate from being in fact achieved.

The prerequisite for permeation is a concentration gradient across the membrane, i.e., the gradient of the chemical potential across the membrane. Permeation performance is greater, the greater the concentration gradient. In the case of concentration polarization, the diffusivity of the fluid is not sufficient to ensure a uniform concentration of the permeating component in the entire feed space of the membrane. Permeation here leads to a drop in concentration of the permeating component of the fluid on the membrane surface, so that concentration C_{S} of the permeating component on the membrane surface is lower than concentration C_{F} of the bulk flow in the feed space, which is illustrated schematically in FIG. 1. This concentration gradient results in the development of a concentration boundary layer in the feed space of the membrane and has a negative effect on the permeation performance of the module.

It has been assumed in the past that effects such as concentration polarization may be disregarded in gas permeation because gases have a high diffusion coefficient. However, it has been found that the high diffusivity of gases in highly permeable membranes such as those used for separation of hydrogen, for example, is not sufficient to ensure a sufficiently rapid mass transport to the membrane.

The present invention proposes a tubular membrane module with which very good permeation rates may be achieved because the structure of the tubular membrane module according to the present invention counteracts permeation-reducing effects and concentration polarization in particular.

This is achieved according to the present invention by providing at least one interspace element between the membrane bodies of the bundled arrangement, thereby reducing the diffusion path to the surface of the membrane bodies for the component of the fluid to be separated.

It has been recognized according to the present invention that the effect of concentration polarization may be effectively suppressed by reducing the diffusion path of the component to be separated. Furthermore, it has been recognized according to the present invention that the surfaces of adjacent membrane bodies with the known tubular membrane modules are not usually spaced an equal distance apart at all points, so this results in diffusion paths of different lengths for different areas of the bundle arrangement. Including interspace elements according to the present invention in the bundle arrangement of the membrane bodies thus permits not only a reduction in the diffusion path of the component to be separated, but also an equalization of the length of the diffusion path, depending on the arrangement of the interspace elements and in particular also depending on the adaptation of the shape of the interspace elements to the geometry of the membrane bodies.

As already indicated, there are various possibilities for designing the interspace elements within the scope of the present invention. Advantageously, they extend essentially over the entire length of the membrane bodies of the tubular membrane module. With regard to an equally long or short diffusion path, preferably in all regions of the tubular membrane module, it has proven advantageous for the shape of the interspace elements to be adapted to the contour of the adjacent membrane bodies. In an advantageous variant of the tubular membrane module according to the present invention, the outsides of the interspace elements are provided with a structure to induce turbulence in the fluid flow. Such turbulence promotes transport of the component to be separated toward a membrane body and counteracts the development of a concentration boundary layer.

Since the interspace elements function primarily to reduce the diffusion path of the component of the fluid to be separated, they may in principle be designed as either solid or hollow elements made of any desired material, preferably inert. However, from the standpoint of a lightweight design of the tubular membrane module according to the present invention and also from the standpoint of any additional functions of the interspace elements, it has proven advantageous for the interspace elements to be designed as tubular hollow bodies.

In an advantageous variant of the tubular membrane module according to the present invention, the interspace elements are also implemented in the form of membrane bodies which are permeable for either the component of the fluid to be separated or another component of the fluid. In this case, the bundle arrangement includes membrane bodies which differ at least in cross-sectional shape and/or cross-sectional size.

In another variant of the tubular membrane module according to the present invention, the wall of the tubular interspace elements has inlet openings or is porous so that another fluid may be fed into the tubular jacket through these interspace elements. This has proven to be advantageous in reforming hydrocarbons in particular, when the tubular membrane module is designed as a membrane reactor. To do so, a catalyst packing is provided in the feed space of the membrane bodies. Then individual components involved in reforming, e.g., hydrocarbons, water and air, may be added through the interspace elements.

However, these interspace elements may also be used to heat the tubular membrane module according to the present invention. To do so, the inside of the tubular interspace elements may be provided with a catalytically active coating or a catalytically active packing may be provided in the interior of the tubular interspace elements to permit internal heating of the tubular membrane module. If the tubular membrane module according to the present invention is used as part of a gas generating system for fuel cell systems, then the hydrogen-containing anode exhaust gas of the fuel cell or the hydrogen-containing raffinate of the gas generating system may be introduced with the addition of air into the interior of the interspace elements, where a reaction associated with the evolution of heat then takes place.

The development of concentration boundary layers on the outside of the membrane body bundle may be effectively counteracted by adapting the geometry of the tubular jacket to the outside contour of the membrane body bundle. In this connection, it has also proven advantageous if the inside of the tubular jacket is provided with a structure to induce turbulence in the fluid flow.

As already explained in detail above, there are various possibilities of embodying and improving upon the teaching of the present invention in an advantageous manner.

### BRIEF DESCRIPTION OF THE DRAWINGS

Reference is made to the claims and to the following description of an exemplary embodiment of the present invention with reference to the drawings, in which:

FIG. 1 shows a schematic diagram of the phenomenon of concentration polarization, which was explained above as part of the introduction to the description;

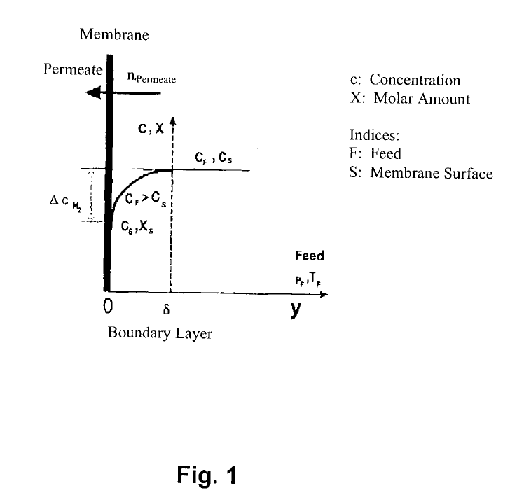

FIG. 2 shows a section through a tubular membrane module known from practice (related art), and

FIG. 3 shows a section through a tubular membrane module according to the present invention.

### DETAILED DESCRIPTION

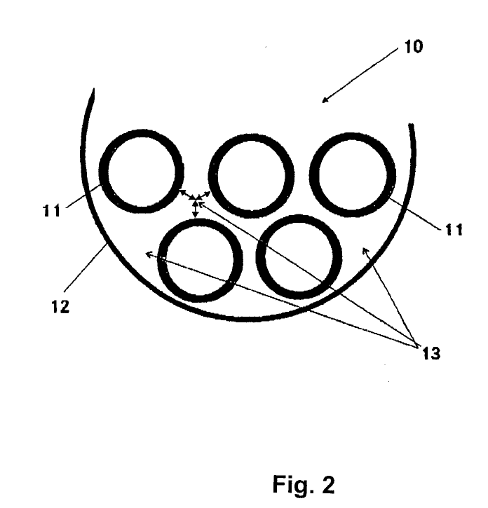

Tubular membrane module 10 shown in FIG. 2 is used in general to separate one component from a fluid containing multiple components. In practice, such tubular membrane modules are used to separate hydrogen from hydrogen-rich reformate gases for motor vehicles operated with fuel cells, for example. The functioning of tubular membrane module 10 is explained below on the basis of this example of an application.

Tubular membrane module 10 includes seven tubular membrane bodies 11, only five of which are shown here. All membrane bodies 11 have the same circular cross section and are bundled together in a common tubular jacket 12, which also has a circular cross section. To separate hydrogen, the hydrogen-rich reformate gas is fed into tubular jacket 12, so that the reformate gas flows through tubular jacket 12. In doing so, hydrogen accumulates in the interior of membrane bodies 11 because the walls of membrane bodies 11 are permeable for hydrogen due to their material and properties, and there is a hydrogen concentration gradient between the outside of membrane bodies 11 and the inside of membrane bodies 11. On the whole, hydrogen permeates through the walls of membrane bodies 11 more rapidly here than do the other components of the reformate gas.

FIG. 2 shows the arrangement of membrane bodies 11, including packing-induced regions 13 where the diffusion path to the wall of the next membrane body 11 is greater than in other regions of the bundled arrangement. These regions 13 are especially susceptible to developing concentration polarization.

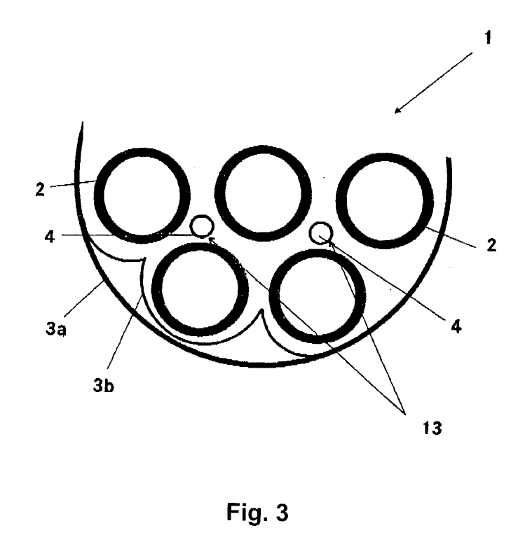

Tubular membrane module 1 according to the present invention, as illustrated in FIG. 3, also includes seven tubular membrane bodies 2, only five of which are shown here. Here again, all membrane bodies 2 have the same circular cross section and are bundled together in a common tubular jacket 3a and/or 3b. The arrangement of membrane bodies 2 in this exemplary embodiment of the present invention thus corresponds to the bundled arrangement illustrated in FIG. 2.

However, in the case of tubular membrane module 1 according to the present invention, interspace elements 4 are provided between membrane bodies 2 in regions 13, thereby reducing the feed space and thus the diffusion path to the surface of the next membrane body 2. This measure counteracts the development of concentration polarization in regions 13.

Tubular membrane module 1 could reasonably include five interspace elements 4, although only two are shown in FIG. 3.

Interspace elements 4 are designed here in the form of tubes having a circular cross section that is smaller than the cross section of membrane bodies 2. The interspace elements could of course also be designed as solid elements and/or they could have some other shape, e.g., adapted to the contour of the adjacent membrane bodies.

As already explained in detail in the introduction to the description, interspace elements 4 may also have another function in addition to that of reducing the feed space. For example, the interspace elements may also be implemented in the form of membrane bodies, or they may be used for feeding another fluid into the tubular jacket. However, the interspace elements may also be used, e.g., to heat the tubular membrane module.

FIG. 3 shows two possibilities for implementing a tubular jacket 3a and/or 3b of tubular membrane module 1 according to the present invention. Tubular jacket 3a has a circular cross section and corresponds essentially to tubular jacket 12 shown in FIG. 2. In contrast with that, the geometry of tubular jacket 3b is adapted to the outside contour of the membrane body bundle.

In conclusion, it should be pointed out that the cross section of the membrane bodies of a tubular membrane module according to the present invention need not be circular but may also have any other shape. Furthermore, not all membrane bodies of a tubular membrane module according to the present invention must have the same cross-sectional shape and size. The number of membrane bodies and interspace elements combined in a tubular membrane module according to the present invention may be varied at will.

What is claimed is:

1. A tubular membrane module, comprising:
a tubular jacket delimiting a flow path for a fluid containing a plurality of components;
a plurality of tubular membrane bodies bundled together in a bundle and disposed in the tubular jacket, each of the tubular membrane bodies having a surface and being permeable for a first component of the plurality of components;
an interspace element disposed between at least two adjacent membrane bodies of the plurality of membrane bodies so as to reduce a diffusion path of the first component to the surface of the membrane bodies.

2. The tubular membrane module as recited in claim 1, wherein the plurality of tubular membrane bodies define a length, and the interspace element extends over the length.

3. The tubular membrane module as recited in claim 1, the interspace element has a shape adapted to a contour of the adjacent membrane bodies.

4. The tubular membrane module as recited in claim 1, wherein an outside of the interspace element includes a structure configured to induce a turbulence in the fluid.

5. The tubular membrane module as recited in claim 1, wherein the interspace element is a tubular hollow body.

6. The tubular membrane module as recited in claim 1, wherein the interspace element includes a supplemental membrane body permeable for a second component of the plurality of components.

7. The tubular membrane module as recited in claim 5, wherein the interspace element is configured to feed a second fluid into the tubular jacket through the interspace element.

8. The tubular membrane module as recited in claim 7, wherein the interspace element includes inlet openings.

9. The tubular membrane module as recited in claim 7, wherein the interspace element is porous.

10. The tubular membrane module as recited in claim 1, wherein the interspace element is configured to heat the tubular membrane module.

11. The tubular membrane module as recited in claim 10, wherein the interspace element includes a catalytically active component disposed inside the interspace element.

12. The tubular membrane module as recited in claim 10, wherein the catalytically active component is in the form of one of a coating or a packing.

13. The tubular membrane module as recited in claim 1, wherein the tubular jacket includes a geometry adapted to an outside contour of the bundle.

14. The tubular membrane module as recited in claim 1, wherein the tubular jacket includes a structure disposed on an inside of the tubular jacket configured to induce a turbulence in the fluid.

15. The tubular membrane module as recited in claim 1, wherein the tubular membrane module forms a part of a gas generating system.

16. The tubular membrane module as recited in claim 15, wherein the gas generating system includes a system to generate a hydrogen-containing gas by reforming hydrocarbons, and wherein the interspace element is configured to feed a component involved in the reforming.

17. The tubular membrane module as recited in claim 1, wherein the tubular membrane module forms a part of a gas generating system for a fuel cell systems, and wherein at least one of a hydrogen-containing anode exhaust gas and a hydrogen-containing raffinate of the gas generating system are introduced with air into the interspace element so as to heat the tubular membrane module.
